(19) United States
(12) Patent Application Publication
(10) Pub. No.: US 2018/0342264 A1
(43) Pub. Date: Nov. 29, 2018

(54) METHOD OF AUTOMATICALLY RECORDING AUDIO CONTENT, AND SYSTEM THEREFOR

(71) Applicant: AnchorFM, Inc., New York, NY (US)

(72) Inventors: Nir Zicherman, Glen Rock, NJ (US); Michael Mignano, Hoboken, NJ (US)

(21) Appl. No.: 15/874,265

(22) Filed: Jan. 18, 2018

Related U.S. Application Data
(60) Provisional application No. 62/448,025, filed on Jan. 19, 2017.

(51) Int. Cl. G11B 20/10; H04W 4/021; G06F 3/16

(52) U.S. Cl. CPC G11B 20/10527; H04W 4/021; G11B 2020/10546; H04R 2499/11; G06F 3/165

(57) ABSTRACT

A method and system for automatically initiating recordation of a conversation over a mobile communication device using a proximity sensor.

### CROSS-REFERENCE TO RELATED APPLICATION

This application claims priority to and the benefit of provisional patent application No. 62/448,025, titled “Method of Automatically Recording Audio Content, and System Therefor” filed on Jan. 19, 2017, the disclosure of which is herein incorporated by reference in its entirety.

### TECHNICAL FIELD

The present invention relates to methods and systems for initiating recordation of audio content and, more particularly, to methods and systems for automatically initiating recordation of audio content over a mobile communication device using a proximity sensor.

### BACKGROUND OF THE INVENTION

Presently, mobile communication devices, e.g., cell phones, smart phones, or the like, require manual user interaction with the mobile communication device to start and stop recordation of audio content by the mobile communication device. For example, some mobile communication devices include one or more applications (“apps”) that may require the user to tap a button or other icon, e.g., an ON/OFF button, visually displayed on a display device associated with the mobile communication device. In some embodiments, a first tap of or physical interaction with the button initiates recordation, while a second tap of or physical interaction with the button ceases recordation.

### SUMMARY OF THE INVENTION

Accordingly, it would be desirable to provide a method of initiating and terminating recordation of audio content over a mobile communication device that does not require the user to tap or otherwise interact with a button or other icon visually displayed on a display device associated with the mobile communication device; but, rather, that uses a proximity sensor to initiate and terminate recordation automatically.

In a first aspect, embodiments of the invention generally related to a method of initiating and/or terminating recordation of audio content via a mobile communication device having a proximity sensor, an audio receiver, and an audio transmitter. In some embodiments, the method includes receiving proximity signals from the proximity sensor, comparing the received proximity signals to a threshold distance, determining a first period of time that the received proximity signals are within the threshold distance, and initiating recordation of the audio content once the first period of time exceeds a first temporal threshold. In some implementations, the method further includes determining a second period of time that the received proximity signals are not within the threshold distance and terminating recordation of the audio content once the second period of time exceeds a second temporal threshold and/or terminating recordation of the audio content once the audio content is interrupted. In some variations, the method includes publishing the recorded audio content.

In a second aspect, embodiments of the invention generally relate to a system for initiating and/or terminating recordation of audio content via a mobile communication device having an audio receiver, an audio transmitter, and a recordation device. In some embodiments the system includes a processing device and a non-transitory machine-readable medium having executable instructions. In some implementations, the executable instructions, when executed by the processing device, configure the system to: receive proximity signals from the proximity sensor, compare (e.g., using a comparator) the received proximity signals to a threshold distance, determine a first period of time that the received proximity signals are within the threshold distance, and initiate recordation of the audio content, on the recordation device, once the first period of time exceeds a first temporal threshold. In some implementations, the executable instructions, when executed by the processing device, configure the system to: determine a second period of time that the received proximity signals are not within the threshold distance; and terminate recordation of the audio content once the second period of time exceeds a second temporal threshold and/or configures the system to terminate recordation of the audio content once the audio content is interrupted. In some variations, the executable instructions, when executed by the processing device, configure the system to publish the recorded audio content.

### BRIEF DESCRIPTION OF THE DRAWINGS

Certain advantages of some embodiments of the invention may be understood by referring to the following description taken in conjunction with the accompanying drawings. In the drawings, like reference characters generally refer to the same parts throughout the different views. Also, the drawings are not necessarily to scale, emphasis instead generally being placed upon illustrating principles of some embodiments of the invention.

FIG. 1 shows a block diagram of an illustrative system for initiating recordation of audio content over a mobile communication device using a proximity sensor in accordance with some embodiments of the present invention; and

FIG. 2 shows a flow diagram of an illustrative method for initiating recordation of audio content over a mobile communication device using a proximity sensor in accordance with some embodiments of the present invention.

### DETAILED DESCRIPTION

In accordance with some embodiments of the present invention, methods and systems automatically initiate recordation of audio content over a mobile communication device using a proximity sensor. Those of ordinary skill in the art can appreciate that audio content may include any spoken word(s) made by the user of the mobile communication device and/or a third party having a conversation with the user, an audible sound(s), and/or a noise(s).

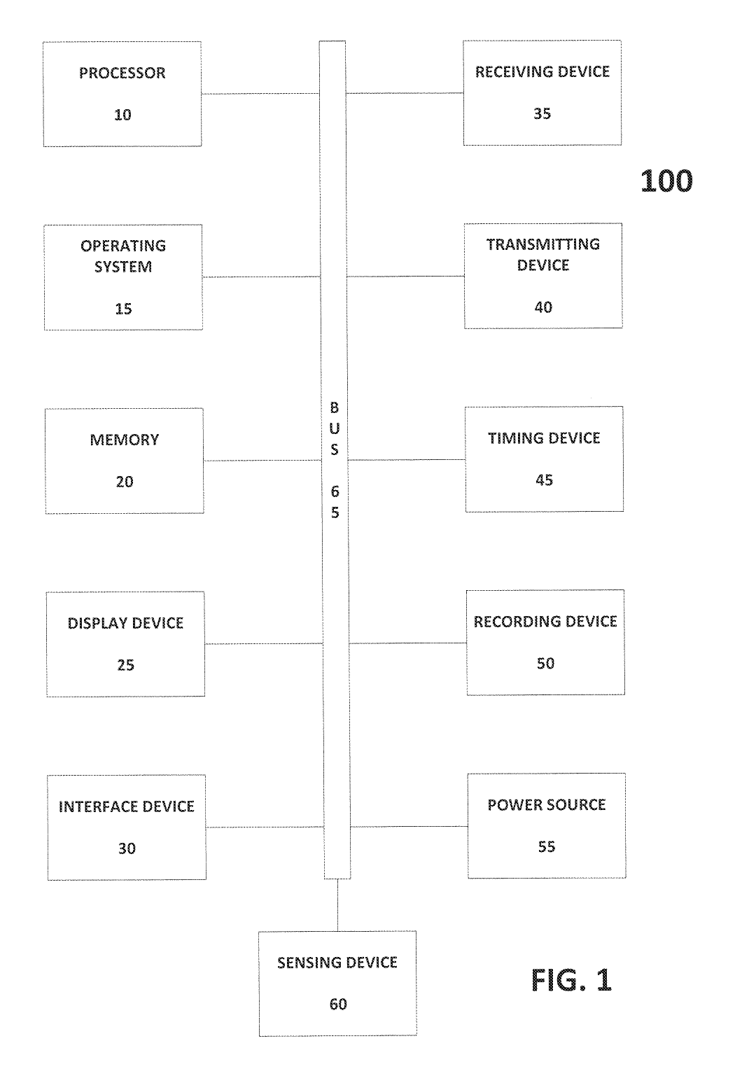

Referring to FIG. 1, in some embodiments mobile communication devices 100, e.g., cell phones, smart phones, or the like, come equipped from their manufacturers with, for the purposes of illustration and not limitation, one or more of: a processor(s) 10, an operating system(s) 15, memory 20, a display device(s) 25, an interface (e.g., input/output (I/O)) device(s) 30, a receiving device 35 (e.g., a microphone, which may be integrated into the device 100 or an external peripheral), a transmitting device 40 (e.g., a speaker), a timing device 45 (e.g., a clock, a stopwatch, or the like), a recording device 50, a power source(s) 55, and one or more sensing devices 60 (e.g., accelerometers, gyroscopes, GPS devices, proximity sensors, or the like).

The processor 10 may be a commercially available processor such as an INTEL® CORE™ processor manufactured by INTEL Corporation of Santa Clara, Calif., a Motorola PowerPC processor manufactured by Motorola, Inc. of Chicago, Ill., an MIPS processor, an UltraSPARC processor originally developed by Sun Microsystems of Menlo Park, Calif. (now Oracle Corporation of Redwood Shores, Calif.), and manufactured by Texas Instruments of Dallas, Tex., or a PA-RISC processor originally manufactured by Hewlett-Packard Company of Palo Alto, Calif., but may be any type of processor or controller as many other processors, microprocessors, and controllers are available. The processor 10 may be structured and arranged to perform a series of instructions, e.g., an application, an algorithm, a driver program, and the like, that result in manipulated data.

An operating system 15 manages at least a portion of the hardware elements included in the mobile communication device 100. Usually, a processor 10 or controller, executes an operating system which may be, for example, a MAC iOS operating system, available from Apple Inc. of Cupertino, Calif., a Linux-based operating system, e.g., Android, available from the Google LLC of Mountain View, Calif., or the like. Other operating systems 15 may be used, and embodiments are not limited to any particular implementation.

The processor 10 and operating system 15 together define a processing platform for which application programs in high-level programming languages may be written. These component applications may be executable, intermediate (for example, C−) or interpreted code which communicate over a communication network (for example, the Internet) using a communication protocol (for example, TCP/IP). Similarly, aspects in accordance with the present invention may be implemented using an object-oriented programming language, such as SmallTalk, Java, C++, Ada, or C# (C-Sharp). Other object-oriented programming languages may also be used. Alternatively, functional, scripting, or logical programming languages may be used.

Additionally, various aspects and functions in accord with the present invention may be implemented in a non-programmed environment, e.g., documents created in HTML, XML or other format that, when viewed in a window of a browser program, render aspects of a graphical-user interface or perform other functions. Furthermore, various embodiments in accordance with the present invention may be implemented as programmed or non-programmed elements, or any combination thereof. For example, a Web page may be implemented using HTML while a data object called from within the web page may be written in C++. Thus, the invention is not limited to a specific programming language. Indeed, any suitable programming language could be used.

Memory 20 may include any device for storing programs and data. For example, memory 20 may be a relatively high performance, volatile, random access memory such as a dynamic random access memory (DRAM) or static memory (SRAM). Additionally, or in the alternate, memory 20 may include a non-volatile storage device. Various embodiments in accordance with the present invention may organize memory 20 into particularized and, in some cases, unique structures to perform the aspects and functions disclosed herein. Data storage for discrete applications and functionality can be components or elements of memory 20 or, in the alternate, can be stand-alone devices.

Various aspects and functions of the mobile communication device 100 may be implemented in software, hardware, firmware, or any combination thereof. Thus, aspects in accord with the present invention may be implemented within methods, acts, systems, system elements, and components using a variety of hardware and software configurations, and the invention is not limited to any particular distributed architecture, network, or communication protocol. To exchange data via a communication network, the processor 10 may use various methods, protocols, and standards, including, inter alia, token ring, Ethernet, TCP/IP, UDP, HTTP, FTP, and SNMP.

In some implementations, the mobile communication device 100 may include one or more interface devices 30 such as input devices, output devices, and/or combined input/output (I/O) devices. Interface devices 30 are adapted to receive input or to provide output. More particularly, output devices may render information for external presentation, for example, on display devices 25. Input devices may accept information from external sources. Examples of interface devices, for the purpose of illustration and not limitation, include keyboards, styluses, receiving devices 35 (e.g., microphones), touch screens, display screens 25, transmitting devices 40 (e.g., speakers), and so forth.

In some variations, the display device 25 of the mobile communication device 100 includes a touch screen capable of depicting images, text, video, or the like on a screen and providing input to the mobile communication device 100.

In some applications, the mobile communication device 100 may include a timing device 45. The timing device 45 may include functionality to provide an accurate time of day as well as a stop watch capability to measure time between events or inputs, such as points of initiation and completion.

In some implementations, the mobile communication device 100 may include functionality for recording images, audio, video, or any combination therefor. For example, and pertinent to the present invention, recording device 50 functionality may include discrete data storage for recording audio content introduced into the (e.g., microphone) receiving device 35 for subsequent transmission via the (e.g., speakers) transmitting device 40.

The power source 55 may include one or more of an energy storage device (e.g., a battery), a power outlet that is readily connectable to an external power source (e.g., a power outlet), and/or a power-generating device. In some variations, the power source 55 is capable of providing power to each of the components of the mobile communication device 100.

Exemplary sensing devices 60 can include, for the purpose of illustration and not limitation, accelerometers, gyroscopes, GPS devices, cameras, proximity sensors, or the like. In particular, proximity sensors that are adapted to sense the proximity of, for example, a portion of the user's body (e.g., ear, hand, face, or the like) and to generate and transmit a signal to the processor 10 once an object has been sensed to be proximate the mobile communication device 100.

The processor 10 and the other elements are interconnected electrically and electronically via an interconnection element such as a bus 65. The bus 65 may include one or more physical busses, e.g., between components that are integrated within a same machine, but may also include any communication coupling between system elements, e.g., specialized or standard computing bus technologies such as IDE, SCSI, PCI, and InfiniBand. Thus, the bus 65 enables communications, e.g., the transfer of data and instructions, to be exchanged between components.

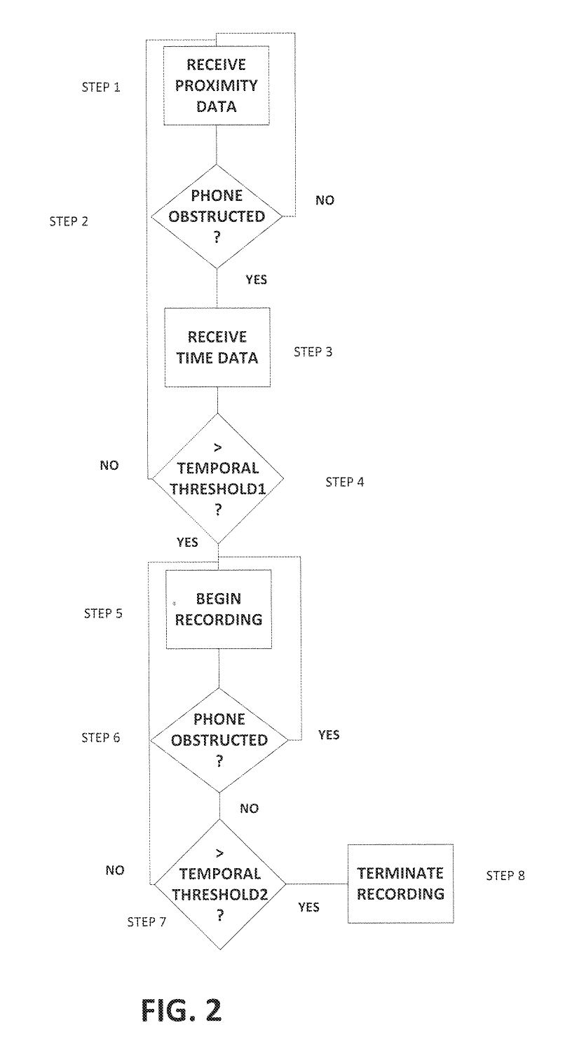

Referring to FIG. 2, an exemplary method of initiating and/or terminating recordation of audio content via a mobile communication device, as well as some of the functions and interactions of the components of the system will be described. Those of ordinary skill in the art can appreciate that the audio content may include words spoken or sung by the user, sounds or noises made by the user or by another person or object.

As previously mentioned, the mobile communication device 100 may include one or more proximity sensors 60 configured, e.g., by the mobile communication device 100 manufacturer, to sense the proximity of an object, e.g., the face, mouth, hand, ears, or the like of the user, and to generate and transmit a signal, e.g., to the processor 10, when the mobile communication device 100 remains obstructed. In a first step, the processor 10 receives one or more signals from the proximity sensor(s) 60 (STEP 1) and determines whether or not the mobile communication device 100 is obstructed (STEP 2). For example, in some implementations, once the processor 10 receives a first signal from the proximity sensor(s) 60, the processor 10 may start a time measuring device, e.g., a clock, stop watch or the like, to measure an amount of time the mobile communication device 100 is obstructed. In some variations, the processor 10 may receive time data from the time measuring device (STEP 3), which is compared to a first temporal threshold (STEP 4) representative of the continuous amount of time that the mobile communication device 100 is obstructed. As long as the first temporal threshold is not exceeded, the processor 10 may continue to receive proximity (STEP 1) and time data (STEP 3).

Once the first temporal threshold is exceeded, in some embodiments, the processor 10 generates a signal to the recording device 50 to record and/or store any discernible audio content (STEP 5), e.g., an audio exchange between the user of the mobile communication device 100 and a third party, broadcast audio, or a combination of both. Optionally, instead of the audio content being recorded or stored on the recording device 50, the audio content may be recorded and/or stored remotely on an external recording device and/or an external data storage device or cloud-based service.

In some embodiments, recordation of the audio content may continue until the mobile communication device 100 is no longer obstructed and/or the audio exchange is interrupted. For example, during the audio exchange and recordation thereof, the processor 10 will continue to receive signals from the proximity sensor(s) 60 and determine whether or not the mobile communication device 100 is obstructed (STEP 6). As long as the proximity signals received indicate that the mobile communication device 100 is still obstructed, recordation of the audio content will continue. However, if the processor 10 receives signals indicating that the mobile communication device 100 is no longer obstructed (STEP 6), the processor 10 may start a time measuring device, e.g., a clock, stop watch or the like, to measure an amount of time the mobile communication device 100 is not being obstructed. In some variations, the processor 10 may receive time data from the time measuring device, which is compared to a second temporal threshold (STEP 7) representative of the continuous amount of time that the mobile communication device 100 is not obstructed. As long as the second temporal threshold is not exceeded, the recording device 50 may continue to record the audio content. However, once the second temporal threshold has been exceeded and/or the audio exchange has been interrupted, in some applications, the processor 10 may generate a signal to the recording device 50 to terminate recording the audio content (STEP 8). Having recorded and stored audio content, the user may selectively broadcast all or some portion of the stored audio content. Broadcasting may include uploading the audio content to a text message, e.g., as an attachment, to a server and/or application (e.g., Instagram, Youtube, Snapchat, or the like).

Having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as illustrative and not restrictive. The configurations, materials, and dimensions described herein are also intended as illustrative and in no way limiting. Similarly, although physical explanations have been provided for explanatory purposes, there is no intent to be bound by any particular theory or mechanism, or to limit the claims in accordance therewith.

What is claimed is:

1. A method of at least one of initiating and terminating recordation of audio content via a mobile communication device, the mobile communication device comprising a proximity sensor, an audio receiver, and an audio transmitter, the method comprising:
receiving proximity signals from the proximity sensor;
comparing the received proximity signals to a threshold distance;
determining a first period of time that the received proximity signals are within the threshold distance; and
initiating recordation of the audio content once the first period of time exceeds a first temporal threshold.

2. The method of claim 1 further comprising:
determining a second period of time that the received proximity signals are not within the threshold distance; and
terminating recordation of the audio content once the second period of time exceeds a second temporal threshold.

3. The method of claim 1 further comprising:
terminating recordation of the audio content once the audio content is interrupted.

4. The method of claim 1 further comprising publishing the recorded audio content.

5. A system for at least one of initiating and terminating recordation of audio content via a mobile communication device, the mobile communication device comprising a proximity sensor, an audio receiver, an audio transmitter, and a recordation device, the system comprising:
a processing device; and
a non-transitory machine-readable medium having executable instructions that, when executed by the processing device, configures the system to:
receive proximity signals from the proximity sensor;
compare, using a comparator, the received proximity signals to a threshold distance;
determine a first period of time that the received proximity signals are within the threshold distance; and
initiate recordation of the audio content, on the recordation device, once the first period of time exceeds a first temporal threshold.

6. The system of claim 5, wherein the non-transitory machine-readable medium further includes executable instructions that, when executed by the processing device, configures the system to:
determine a second period of time that the received proximity signals are not within the threshold distance; and
terminate recordation of the audio content once the second period of time exceeds a second temporal threshold.

7. The system of claim 5, wherein the non-transitory machine-readable medium further includes executable instructions that, when executed by the processing device, configures the system to:
terminate recordation of the audio content once the audio content is interrupted.

8. The system of claim 5, wherein the non-transitory machine-readable medium further includes executable instructions that, when executed by the processing device, configures the system to:
publish the recorded audio content.
